(19) United States
(12) Patent Application Publication
(10) Pub. No.: US 2017/0312166 A1
(43) Pub. Date: Nov. 2, 2017

(54) KNIT MASSAGING CLOTHING

(71) Applicant: HANES OPERATIONS EUROPE SAS, Rueil-Malmaison (FR)

(72) Inventors: Nicolas Viau, Tours (FR); Laurent Massotte, Tavernay (FR); Florent Moret, Autun (FR)

(73) Assignee: HANES OPERATIONS EUROPE SAS, Rueil-Malmaison (FR)

(21) Appl. No.: 15/522,759

(22) PCT Filed: Oct. 23, 2015
(86) PCT No.: PCT/IB2015/058199

§ 371 Date: Apr. 27, 2017

(30) Foreign Application Priority Data
Oct. 31, 2014 (FR) 14/60510

(51) Int. Cl. A61H 7/00; A41D 31/00; A41D 1/06; A41D 27/10

(52) U.S. Cl. CPC A61H 7/001; A41D 27/10; A41D 31/00; A41D 1/06; A61H 2201/165; A41D 2400/322; A61H 2201/169; A61H 2205/10; A61H 2207/00; A41D 2500/10

(57) ABSTRACT

The disclosure concerns a knit massaging item of clothing to be worn by a person, comprising at least a raised knit active portion (14) to be pressed against the skin of the person wearing it so as to massage the skin, characterized in that the active portion (14) includes multiple protruding beads (22) designed to massage the person.

### TECHNICAL FIELD

The disclosure concerns a knit piece of clothing to act on the appearance of the skin of the person wearing it and in particular on cellulite.

The disclosure applies to any clothing item aimed at being worn preferably against the skin of the person wearing it and preferably covering body cellulite parts.

As a non-limiting example, the clothing item can be shorts, tight trousers, tapered trousers, sleeves, etc.

### BACKGROUND

Numerous types of clothing are known aimed at having an impact on cellulite, such as so-called “micro-massaging” clothes that comprise a raised textile aimed at reproducing the action of a “palpating-rolling” massage on the skin.

This massage is aimed among other at accelerating blood circulation to participate in the slimming action.

For that purpose, it is known to provide the textile forming the clothing with picots for which the protruding free end presses against the skin of the person wearing it to massage it.

This “micro-massaging” type of clothing is sometimes associated with active agents aimed at firming up, slimming down or hydrate the skin for instance.

For that purpose, the active agents are impregnated in the fibers of the clothing and are released progressively by rubbing the fabric against the skin.

An inconvenience of this type of active agent impregnated fibers is its loss of efficiency over time due to successive washing of the clothing item.

### SUMMARY

This disclosure is aimed among other at improving the massaging effect of the clothing item and at proposing an efficient item of clothing over time.

For that purpose, the disclosure proposes a knit massaging piece of clothing aimed at being worn by a person, comprising at least an active portion of the raised knitted part that is to be pressing against the skin of the person wearing it to massage the skin, characterized in that the active portion comprises multiple protruding beads to massage the person.

The beads provide the benefit of offering a greater continuous contact surface with the skin than picots to improve the massaging effect of the clothing item.

Preferably, to amplify the massage, each bead has the shape of an overall sinusoidal wave.

Also, the beads are overall arranged in parallel among themselves so that the action portion forms alternating mounds and depressions.

In addition, the beads are spaced regularly among each other.

According to another feature, each bead has a section that is overall convex in shape for which the top is adapted to be resting on the skin of the person and to massage the skin of the person when the latter is moving about.

According to a variant of embodiment, the beads are made up of at least a first type of beads that have a first section type, and a second type of beads that have a second section type, with the first type of beads and the second type of beads being arranged in alternation.

Beneficially, the beads are designed to extend throughout around the limbs of the person wearing the item of clothing.

According to another appearance, the piece of clothing can be deformed elastically so as to compress substantially the person wearing it to provide a supporting effect.

According to a variant of embodiment, it comprises at least one active portion strip and a second active portion strip that can be elastically deformed and which are made to compress substantially the person wearing it each according to a different force.

In addition, the active portion is made by means of at least an active fiber designed to reflect the infrared rays emitted by the body towards the person wearing it.

Preferably, the active fiber is a fiber that comprises ceramic crystals.

### BRIEF DESCRIPTION OF THE DRAWINGS

Other features and benefits of the disclosure will appear upon reading the detailed description that follows. For its comprehension, please refer to the attached drawings in which:

FIG. 1 is a schematic front view that illustrates an item of clothing comprising an active portion forming multiple raised massaging beads according to the disclosure;

FIG. 2 is a schematic side view that illustrates the piece of clothing of FIG. 1;

FIG. 3 is a schematic rear view that illustrates the item of clothing for FIG. 1;

FIG. 4 is a schematic detailed view according to frame IV of FIG. 1 that illustrates the beads of the active portion;

FIG. 5 is a schematic sectional view according to line 5-5 of FIG. 4 that illustrates the profile of the massaging beads.

### DETAILED DESCRIPTION

To clarify the description and claims, the longitudinal, vertical and transversal terminology as non-limiting will be adopted in reference to the L, V, T triad shown in the figures.

In this disclosure, the terms “top”, “bottom”, “vertical” and their derivatives make reference to the position or orientation of an element or components with such position or orientation being considered when the person wearing the clothing is standing upright on a horizontal surface.

For all these figures, identical or analogous references represent components or assemblies of identical or analogous components.

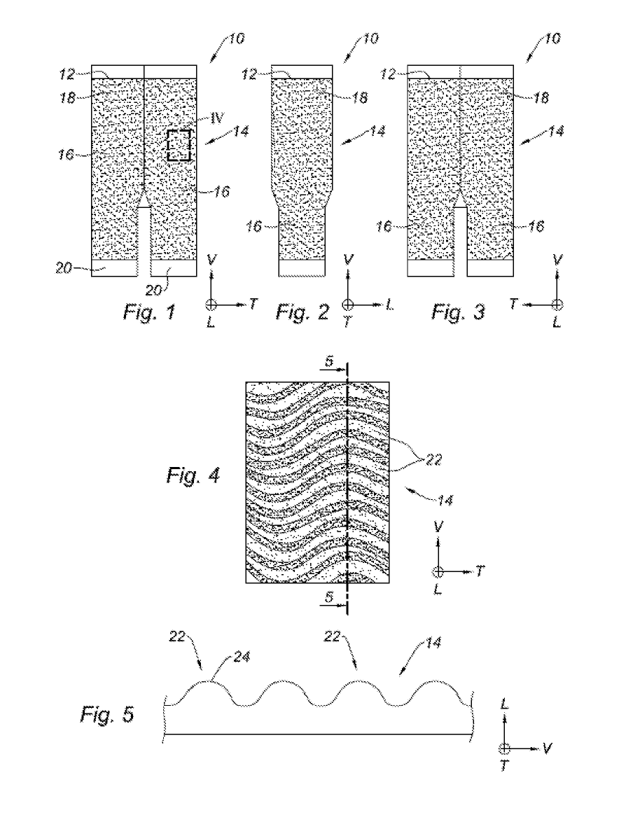

In FIG. 1, a knit item of clothing 10 has been shown, here tight trousers, to be worn by a person, preferably against the skin.

Item of clothing 10 includes a top strip 12 with a knit elastic belt, an active portion 14 illustrated by a bunch of points in FIGS. 1 to 3 that form both vertical legs (16 and the shorts 18 of the item of clothing 10, and a bottom knit elastic strap 20 arranged at the end of each leg 16.

Also, active portion 14, that is to be pressing against the skin of the person wearing it, is knit.

In accordance with the disclosure, active portion 14 includes a protruding multitude of beads 22, illustrated on FIG. 4, designed to massage the person.

For that purpose, beads 22 each form a slender bulge that is raised from a bottom face of the piece of clothing, towards the skin of the person wearing it.

In addition, beads 22 are overall arranged in parallel among each other to be superimposed vertically, so that the active portion 14 forms alternatingly bulges and depressions as can be seen on FIG. 5.

Preferably, the beads 22 have each the shape of a sinusoidal wave to increase the massaging effect of the skin of the person wearing the piece of clothing 10.

However, without limitation, the beads 22 can have an overall straight line shape.

With reference to FIG. 4, the beads 22 are interwoven and are regularly (e.g., evenly) spaced among themselves.

As can be seen on the section of FIG. 5, each bead 22 has an overall convex shaped section for which the top 24 presses against the skin of the person and massages the skin of that person when the latter is moving about.

Beneficially, the top 24 of each bead 22 forms a continuous line that presses against the skin which permits covering a large part of the person's skin.

According to another aspect, the beads 22 are designed to extend overall and around limbs of the person wearing the clothing item, more specifically around the legs and the pelvis of the person.

In addition, clothing item 10 according to the disclosure can be deformed elastically so as to compress substantially the person wearing it to provide a supporting effect favoring massaging by the action portion 14.

Also, the active portion 14 is of the thermo-regulating type and is made of active fiber designed to reflect the infrared rays emitted by the body towards the skin of the person wearing it.

The active fiber is a polyamide fiber that includes ceramic crystals. This type of active fiber is known by the commercial name of “Emana®”.

According to a variation of embodiment not shown, clothing item 10 includes a first strip of active portion and a second strip of active portion that can be deformed elastically and which are made to compress substantially the person wearing, each with a different force.

This feature permits among other to provide a stronger massage on certain targeted areas of the person's skin.

According to another variant of embodiment of the disclosure which is not shown, beads 22 of the clothing item 10 consist of at least a first type of beads that show a first type of section, and a second type of beads that show a second type of section, with the first and second type of beads being arranged in alternation.

“Type of section” is understood to be a vertical section of a particular geometry as well as particular dimensions, such as a particular vertical width and a longitudinal height.

1. A knit massaging item of clothing to be worn by a person, the knit massaging item of clothing comprising a raised active portion configured to be in contact with skin of the person to massage the skin, wherein the active portion is a raised knitted part of the knit massaging garment and includes multiple protruding beads formed in the raised active portion and configured to massage the skin.

2. The knit massaging item of clothing according to claim 1, wherein each bead of the multiple protruding beads has the shape of a wave which is sinusoidal overall.

3. The knit massaging item of clothing according to claim 1, wherein the multiple protruding beads are arranged overall in parallel with each other, so that the raised active portion forms an alternation of bulges and depressions.

4. The knit massaging item of clothing according to claim 1, wherein the multiple protruding beads are spaced evenly among themselves in the raised active portion.

5. The knit massaging item of clothing according to claim 1, wherein each bead of the multiple protruding beads includes a section with an overall convex shape for which a top of the bead is adapted to press against the skin of the person and to massage the skin of the person when the person moves about.

6. The knit massaging item of clothing according to claim 1, wherein the multiple protruding beads comprise at least a first type of beads that have a first type of section, and a second type of beads that have a second type of section different from the first type of section, with the first type of beads and the second type of beads being arranged in alternation in the raised active portion.

7. The knit massaging item of clothing according to claim 1, wherein the multiple protruding beads are configured to extend overall around limbs of the person wearing it.

8. The knit massaging item of clothing according to claim 1, wherein the knit massaging item of clothing can be deformed elastically so as to compress substantially the person wearing the knit massaging item of clothing to provide a supporting effect.

9. The knit massaging item of clothing according to claim 1, wherein the raised active portion is a first active portion strip, the knit massaging item of clothing comprising a second active portion strip that can be deformed elastically, wherein the first elastic portion strip and the second elastic portion strip are made to compress substantially the person wearing the knit massaging item of clothing, each with a different force.

10. The knit massaging item of clothing according to claim 1, wherein the raised active portion is made with at least an active fiber configured to reflect infrared rays emitted by the body of the person towards the skin of the person wearing the knit massaging item of clothing.

11. The knit massaging item of clothing according to claim 10, wherein the active fiber includes ceramic crystals.

12. The knit massaging item of clothing according to claim 11, wherein the active fiber comprises a polyamide fiber including the ceramic crystals.

13. The knit massaging item of clothing of claim 1, wherein the raised active portion is knit as part of the knit massaging item of clothing.

14. The knit massaging item of clothing according to claim 2, wherein the multiple protruding beads are arranged overall in parallel with each other, so that the raised active portion forms an alternation of bulges and depressions.

15. The knit massaging item of clothing according to claim 14, wherein the multiple protruding beads are spaced evenly among themselves in the raised active portion.

16. The knit massaging item of clothing according to claim 3, wherein the multiple protruding beads are spaced evenly among themselves in the raised active portion.

17. The knit massaging item of clothing according to claim 2, wherein the multiple protruding beads are spaced evenly among themselves in the raised active portion.

18. The knit massaging item of clothing according to claim 2, wherein each bead of the multiple protruding beads includes a section with an overall convex shape for which a top of the bead is adapted to press against the skin of the person and to massage the skin of the person when the person moves about.

19. The knit massaging item of clothing according to claim 5, wherein the multiple protruding beads comprise at least a first type of beads that have a first type of section, and a second type of beads that have a second type of section different from the first type of section, with the first type of beads and the second type of beads being arranged in alternation in the raised active portion.

20. The knit massaging item of clothing according to claim 1, wherein the knit massaging item of clothing comprises at least one of shorts, trousers, or sleeves.
